(19) United States
(12) Patent Application Publication
(10) Pub. No.: US 2025/0237234 A1
(43) Pub. Date: Jul. 24, 2025

(54) POOL PUMP WITH COOLING APPARATUS

(71) Applicant: SPLASH POOL & SPA, INC., Ningbo (CN)

(72) Inventors: Huaiping WANG, Ningbo City (CN); Paul LAMBOURN, Johannesburg (ZA); Michael Richard TREGONING, Evendale (ZA)

(21) Appl. No.: 19/027,302

(22) Filed: Jan. 17, 2025

Related U.S. Application Data
(60) Provisional application No. 63/622,204, filed on Jan. 18, 2024.

(51) Int. Cl. F04D 29/58; F04D 25/06; F04D 29/70

(52) U.S. Cl. CPC F04D 29/588; F04D 25/06; F04D 29/708

(57) ABSTRACT

A pool pump with cooling apparatus includes a motor having a drive shaft, a shroud including a space to house the motor, and a vent intake formed in a rear portion of the shroud. The apparatus also includes a fan positioned adjacent to the vent intake and coupled to the first end of the drive shaft. A control electronics module is in electrical communication with the motor and positioned within the shroud. In addition, the apparatus includes a ventilation passageway formed between the shroud and the motor, where the fan is configured to draw air in through the vent intake and through the ventilation passageway to cool the motor and the control electronics module. A thermoelectric cooler may be positioned between the ventilation passageway and the control electronics module to cool the control electronics module.

### RELATED APPLICATIONS

This application claims priority to U.S. Provisional Application Ser. No. 63/622,204 filed on Jan. 18, 2024, the contents of which are herein incorporated by reference in their entirety.

### FIELD

The present invention relates to the field of pool cleaning equipment, and more particularly, to a pool pump with cooling apparatus.

### BACKGROUND

Modern swimming pool pumps typically utilize totally-enclosed, fan cooled (TEFC) motors to drive the pump impeller. In such motors, the stator and rotor are completely enclosed in a housing, with one end of the drive shaft extending out one end the housing to engage the pump impeller and the opposite end of the drive shaft connected to a cooling fan mounted inside a cover on the other end of the housing. The fan draws air in through the cover and exhaust it over the exterior of the housing, which often incorporates fins or the like facilitate heat transfer.

Modern pumps, and especially programmable variable speed pumps, often have control electronics mounted on top of the motor housing. The control electronics control the supply of electrical power to the motor and execute whatever program instructions have been specified by the manufacturer, installer, and/or user. While such arrangements are generally robust and reliable, overheating can result in damage to the pump and, more frequently, to the control electronics.

Accordingly, there is a need in the art for an improved system to efficiently cool the motor and control electronics of pool pumps.

### SUMMARY

A pool pump with cooling apparatus is disclosed. The pool pump includes a motor having a drive shaft, where the drive shaft has a first end and a second end. The pool pump also includes cooling apparatus comprising a shroud having a space to house the motor, a vent intake formed in a rear portion of the shroud, and a fan positioned adjacent to the vent intake and coupled to the first end of the drive shaft. In addition, the pool pump includes a control electronics module in electrical communication with the motor and positioned within the shroud, and a ventilation passageway formed between the shroud and the motor. The control electronics module may be positioned above the motor. The fan is configured to draw air in through the vent intake and through the ventilation passageway to cool the motor and the control electronics module. The ventilation passageway passes in part under the control electronics module and the ventilation passageway may be alongside the entire length of the motor.

The cooling apparatus of the pool pump may also include a thermoelectric cooler positioned between the ventilation passageway and the control electronics module. The thermoelectric cooler has a first side adjacent to the control electronics module configured to cool the control electronics module and a second opposing side adjacent to the ventilation passageway. The thermoelectric cooler may comprise a Peltier cooling pad.

The shroud may include a top venting shroud configured to fit over the control electronics module, a bottom venting shroud configured to fit over a lower portion of the motor, and an exhaust vent configured for the air from the vent intake to be discharged. The motor may be a variable speed motor, or a totally enclosed fan-cooled (TEFC) motor, for example.

The pool pump may include a filter assembly having an impeller where the impeller is coupled to the second end of the drive shaft and the shroud is configured to extend at least partially over the filter assembly.

In another aspect, a method of cooling a pool pump is disclosed using the cooling apparatus described above. The method includes drawing air in through the vent intake and through the ventilation passageway to cool the motor and the control electronics module.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is an elevational view of a pool pump with cooling apparatus in which various aspects of the disclosure may be implemented;

FIG. 2 is a cross-sectional view taken along line 2-2 of FIG. 1; and

FIG. 3 is a partially exploded perspective view of the cooling apparatus of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The traditional pool pump includes an air intake at the back of the motor, which pulls air through an inlet grate and then exhausts the air in an uncontrolled open manner. The present invention of a pool pump with cooling apparatus is directed to ducting the air, so it flows around the motor and underneath control electronics module located at the top of the motor. Accordingly, this is a significant improvement to cooling the motor, which prolongs the life of the motor and in addition, improves cooling of the associated electronics that are sensitive to temperature. To further assist in cooling the electronics, a thermoelectric cooler such as a Peltier cooling pad may be positioned between the motor and the electronics as explained below.

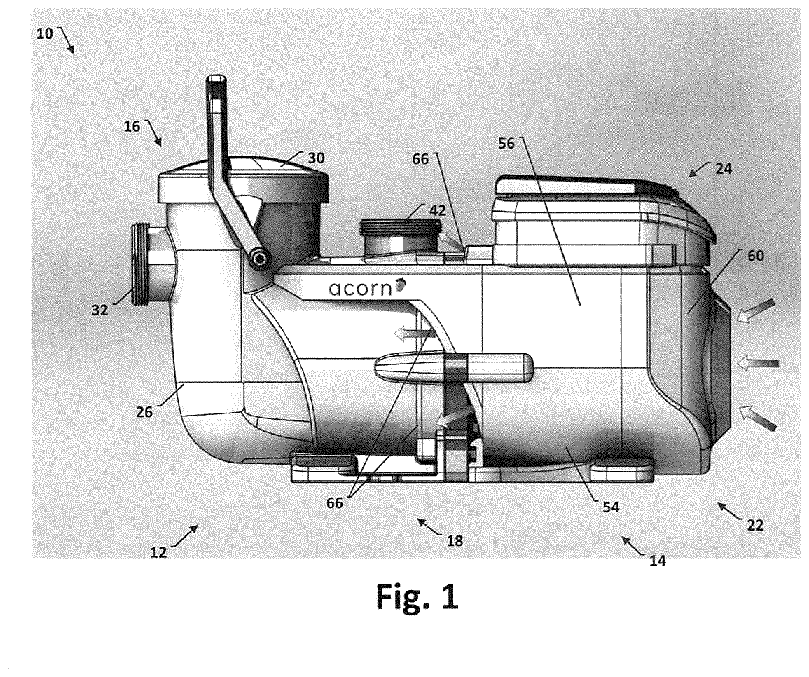

Referring now to FIG. 1, a pool pump with cooling apparatus is generally designated 10. The swimming pool pump 10 includes an impeller section 12 and motor section 14. The impeller section 12 includes a filter assembly 16 and an impeller assembly 18. The motor section includes a motor 20 and a control electronics module 24. The cooling apparatus comprises a shroud 22 that enhances airflow around the motor 20 and between the motor 20 and the control electronics module 24 as explained in more detail below.

The filter assembly 16 includes a filter housing 26 with a removable cover 30 in which a filter basket (not shown) is removably accommodated. A pump water inlet 32 extends into the filter housing 26. For reference purposes only, the water inlet 32 is located on the “front” of the pump 10.

The impeller assembly 18 includes an impeller chamber 34 accommodating a pump impeller 36 mounted to a front end (or first end) of a drive shaft 40 of the motor 20. A pump water outlet 42 extends out the top of the impeller chamber 34. The impeller chamber 34 receives water from the filter housing 26 after it passes through the filter basket, with pressurized water being discharged through the outlet 42.

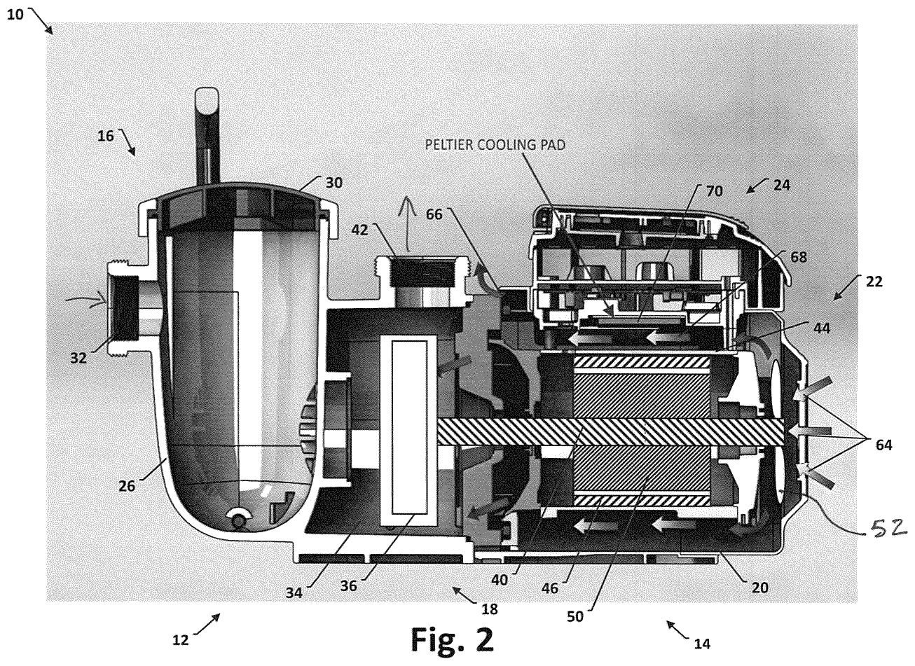

Referring now to FIG. 2, the motor 20 is mounted rearwardly of the impeller chamber 34 and includes a motor housing 44 completely enclosing a stator 46 and a rotor 50. The drive shaft 40 is connected to the rotor 50. The front end of the drive shaft 40 extends out a front end of the motor housing 44 into the impeller chamber 34 where the impeller 36 is mounted. A rear end of the shaft 40 extends out a rear end of the housing 44 and carries a fan 52.

The shroud 22 extends around a circumference of the motor housing 44 and behind a rear end thereof. The shroud 22 is advantageously formed of a bottom venting shroud 54, a top venting shroud 56 and a vent intake 60. The bottom venting shroud 54 is closely contoured to the bottom of the motor housing 44. The top venting shroud 56 meets the bottom shroud 54 on opposite sides of the motor housing 44 and includes an electronics opening 62 in which the control electronics module 24 is accommodated.

The vent intake 60 meets rear ends of the bottom and top venting shrouds 54, 56 and includes apertures 64 through which the fan 52 draws airflow for cooling. Airflow exits through gaps 66 between front ends of the bottom and top venting shrouds 54, 56 and the rear of the impeller chamber 34 as indicated by the arrows in FIG. 1.

Notably, with the control electronics module 24 effectively forming part of the shroud 22 by seating in the top venting shroud 56, airflow is directed through the passageway 68 between the control electronics module 24 and the motor housing 44. To further enhance cooling effects, a thermoelectric cooler 70, such as a Peltier cooling pad, may be coupled to the control electronics module 24 with the hot side exhausting heat into the passageway 68 for removal by the airflow therethrough. Cooling the pool pump 20 is critical because excessive heat can cause premature degradation of internal components like seals, bearings, and motors. Cooling prevents overheating and extends the lifespan of the pool pump 20. In addition, if the pool pump has an integrated variable speed drive (VSD) or other electronics, cooling helps prevent damage to these heat-sensitive parts.

Further, the motor 20 operates more efficiently when running cooler because overheating can lead to energy losses and reduced water circulation capacity. In particular, the cooler pump motor 20 works within its optimal temperature range, requiring less energy to operate and lowering electricity costs. Many modern pool pumps have thermal cutoffs that shut down the pump if it overheats, leading to downtime. Cooling ensures continuous operation. Proper cooling of the motor 20 is an essential part of maintaining an efficient and cost-effective swimming pool system.

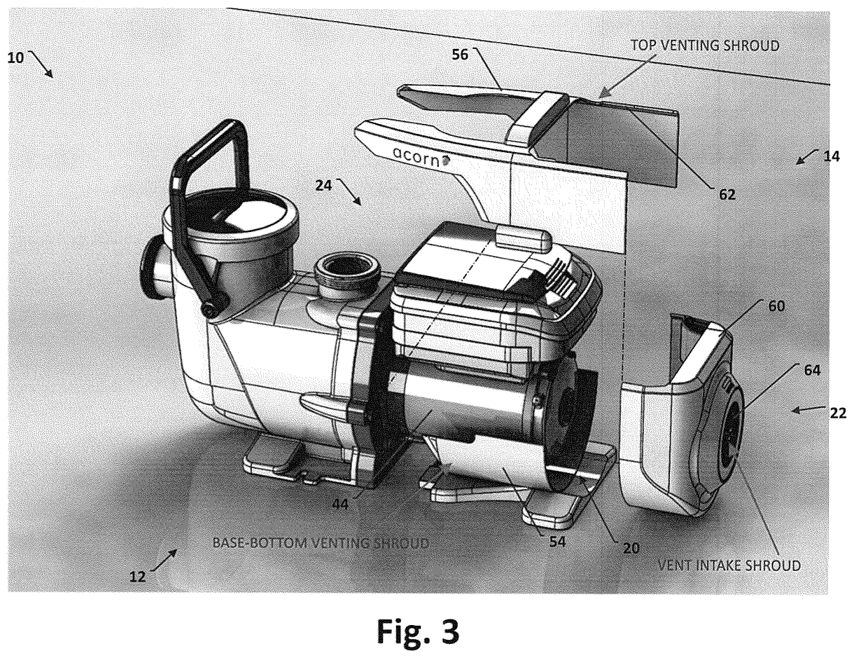

Referring now to FIG. 3, the various shrouds of the cooling system are shown before installation on to a TEFC pump. TEFC pumps are designed to keep their internal components sealed off from external contaminants like dust and water while maintaining efficient operation through a built-in cooling mechanism. TEFC pumps come equipped with an external fan mounted on the motor shaft. The fan draws ambient air over the external frame of the motor to dissipate heat generated during operation. This is usually sufficient under normal operating conditions and environments. However, for environments with higher ambient temperatures, restricted airflow, or heavy-duty operation, the external fan is not sufficient.

For example, the top venting shroud 52 of the present invention is configured to slide down around the control electronics module 24 and partially over the impeller section 12. The top venting shroud 56 includes side panels that extend downward around a top portion of the motor housing 44. The bottom venting shroud 54 has a curved shape that follows the shape of the lower portion of the motor housing 44. Accordingly, the shroud 22 of present invention directs the airflow so it flows around the motor 20 and underneath control electronics module 24 located at the top of the motor 20. Accordingly, this is a significant improvement to cooling the motor 20, which increases the efficiency and the life of the motor.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A pool pump with cooling apparatus comprising:
a motor having a drive shaft, the drive shaft having a first end and a second end;
a shroud including a space to house the motor;
a vent intake formed in a rear portion of the shroud;
a fan positioned adjacent to the vent intake and coupled to the first end of the drive shaft;
a control electronics module in electrical communication with the motor and positioned within the shroud; and
a ventilation passageway formed between the shroud and the motor, the fan configured to draw air in through the vent intake and through the ventilation passageway to cool the motor and the control electronics module.

2. The pool pump with cooling apparatus of claim 1, further comprising a thermoelectric cooler positioned between the ventilation passageway and the control electronics module.

3. The pool pump with cooling apparatus of claim 2, wherein the thermoelectric cooler having a first side adjacent to the control electronics module configured to cool the control electronics module and a second opposing side adjacent to the ventilation passageway.

4. The pool pump with cooling apparatus of claim 3, wherein the thermoelectric cooler comprises a Peltier cooling pad.

5. The pool pump with cooling apparatus of claim 1, wherein the shroud comprises a top venting shroud configured to fit over the control electronics module.

6. The pool pump with cooling apparatus of claim 5, wherein the shroud comprises a bottom venting shroud configured to fit over a lower portion of the motor.

7. The pool pump with cooling apparatus of claim 6, wherein the shroud comprises an exhaust vent configured for the air from the vent intake to be discharged.

8. The pool pump with cooling apparatus of claim 1, further comprising a filter assembly having an impeller and the impeller coupled to the second end of the drive shaft.

9. The pool pump with cooling apparatus of claim 8, wherein the shroud is configured to extend at least partially over the filter assembly.

10. The pool pump with cooling apparatus of claim 1, wherein the ventilation passageway passes in part under the control electronics module.

11. The pool pump with cooling apparatus of claim 1, wherein the control electronics module is positioned above the motor.

12. The pool pump with cooling apparatus of claim 1, wherein the motor comprises a variable speed motor.

13. The pool pump with cooling apparatus of claim 1, wherein the motor comprises a totally enclosed fan-cooled (TEFC) motor.

14. The pool pump with cooling apparatus of 1, wherein the ventilation passageway is alongside the entire length of the motor.

15. A pool pump with cooling apparatus comprising:
a motor having a drive shaft, the drive shaft having a first end and a second end;
a shroud including a space to house the motor;
a vent intake formed in a rear portion of the shroud;
a control electronics module in electrical communication with the motor and positioned within the shroud;
a ventilation passageway formed between the shroud and the motor; and
a thermoelectric cooler positioned between the ventilation passageway and the control electronics module.

16. The pump cooling apparatus of claim 15, further comprising a fan positioned adjacent to the vent intake and coupled to the first end of the drive shaft, wherein the fan is configured to draw air in through the vent intake and through the ventilation passageway to cool the motor and the control electronics module.

17. The pool pump with cooling apparatus of claim 15, wherein the thermoelectric cooler having a first side adjacent to the control electronics module configured to cool and a second opposing side adjacent to the ventilation passageway.

18. The pool pump with cooling apparatus of claim 15, wherein the motor comprises a totally enclosed fan-cooled (TEFC) motor.

19. A method of cooling a pool pump with an apparatus comprising a motor, a shroud including a space to house the motor, a vent intake formed in a rear portion of the shroud, a fan positioned adjacent to the vent intake and coupled to the motor, a control electronics module in electrical communication with the motor and positioned within the shroud, and a ventilation passageway formed between the shroud and the motor, the method comprising:
drawing air in through the vent intake and through the ventilation passageway to cool the motor and the control electronics module.

20. The method of claim 19, further comprising operating a thermoelectric cooler positioned between the ventilation passageway and the control electronics module to cool the control electronics module.
